(19) United States
(12) Patent Application Publication
(10) Pub. No.: US 2026/0071660 A1
(43) Pub. Date: Mar. 12, 2026

(54) MONOBLOCK DISC BRAKE CALIPER

(71) Applicant: Fox Factory, Inc., Duluth, GA (US)

(72) Inventor: Bill Becker, Aptos, CA (US)

(21) Appl. No.: 18/828,936

(22) Filed: Sep. 9, 2024

(51) Int. Cl. F16D 65/00; F16D 55/00; F16D 55/228; F16D 65/18; F16D 121/04

(52) U.S. Cl. CPC F16D 65/0068; F16D 65/18; F16D 2055/0016; F16D 55/228; F16D 2121/04; F16D 2250/00

(57) ABSTRACT

A monoblock disc brake caliper is provided. The monoblock disc brake caliper includes an inner portion, an outer portion, and a crossover portion formed between the inner portion and the outer portion. The inner portion, the outer portion and the crossover portion are formed as a single, unitary body. The monoblock disc brake caliper further includes a transfer port aperture formed in the crossover portion located at a centerline of the monoblock disc brake caliper. The monoblock disc brake caliper further includes an inner transfer port extending from the transfer port aperture to an inner piston bore and an outer transfer port extending from the transfer port aperture to an outer piston bore. The monoblock disc brake caliper further includes a transfer port plug that is coupled to the transfer port aperture to seal the transfer ports with a single plug.

### BACKGROUND OF THE INVENTION

### Technical Field

This invention relates generally to disc brake calipers and more particularly to a monoblock disc brake caliper.

### State of the Art

Monoblock multi-piston disc brake calipers are made from a single piece of metal with pistons on both sides of the caliper. This is done to increase strength and rigidity in the braking system, which improves the feel at the lever. Some existing monoblock disc brake calipers utilize proprietary processes and tooling in order to bore the fluid transfer ports from one side of the monoblock caliper to the other side. Other manufacturers have developed other ways to bore the transfer ports, such as, boring through the rear of the caliper and welding plugs in place afterward for each transfer port or utilizing screw-in plugs. These conventional monoblock brake calipers have several drawbacks, such as, increased machined features and cost for the boring of transfer ports (communication ports), requiring several ports created when boring the transfer ports that need to be sealed and plugged, and creating a less solid brake lever feel due to the number of sealed ports.

Accordingly, there is a need for an improved monoblock disc brake caliper that provides the strength and benefits of monoblock calipers but overcome the drawbacks described above by using a single transfer port plug.

### SUMMARY OF THE INVENTION

An embodiment includes a monoblock disc brake caliper comprising: an inner portion; an outer portion; a crossover portion formed between the inner portion and the outer portion, wherein the inner portion, the outer portion and the crossover portion are formed as a single, unitary body; a transfer port aperture formed in the crossover portion located at a centerline of the monoblock disc brake caliper; an inner transfer port extending from the transfer port aperture to an inner piston bore; and an outer transfer port extending from the transfer port aperture to an outer piston bore.

Another embodiment includes a method of manufacturing a monoblock disc brake caliper, the method comprising: forming a monoblock disc brake caliper having an inner portion with an inner piston bore and an outer portion an outer piston bore, wherein the caliper is a single unitary body; forming a transfer port aperture that extends into a crossover portion that connects the inner portion to the outer portion of the caliper, wherein the transfer port aperture is located at a centerline between the inner portion and the outer portion; forming an inner transfer port extending from the transfer port aperture to the inner piston bore; and forming an outer transfer port extending from the transfer port aperture to the outer piston bore.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a monoblock disc brake caliper coupled to a rotor according to an embodiment;

FIG. 2 is a section view of a monoblock disc brake caliper coupled to a rotor according to an embodiment; and

FIG. 3 is a flow chart of a method of manufacturing a monoblock disc brake caliper according to an embodiment.

### DETAILED DESCRIPTION OF EMBODIMENTS OF THE INVENTION

As discussed above, embodiments of the present invention relate to monoblock disc brake caliper having a single transfer port plug.

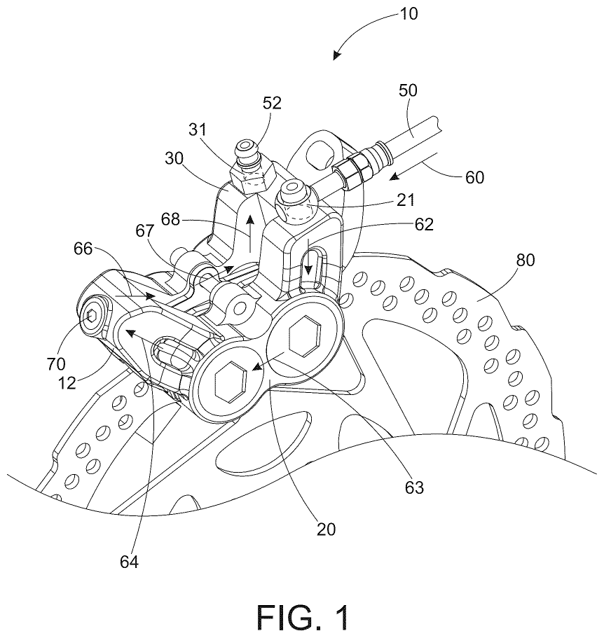

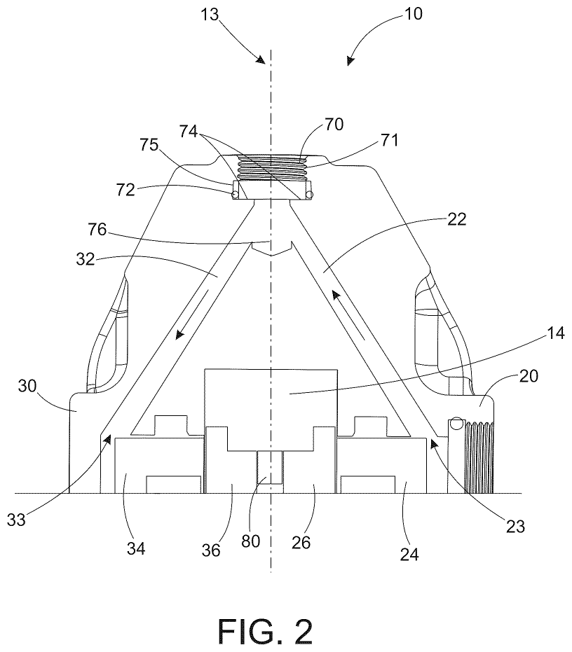

Referring to the drawings, FIGS. 1 and 2 depict a monoblock disc brake caliper 10 according to an embodiment. The caliper 10 includes an inner portion 20 and an outer portion 30 with a crossover portion 12 formed between the inner portion 20 and the outer portion 30, wherein the inner portion 20, outer portion 30 and crossover portion 12 are formed as a single, unitary body. The inner portion 20 includes inner piston(s) 24 coupled within the inner portion 20, the inner piston(s) 24 operating to move an inner brake pad 26 toward and away from a rotor 80 in order to apply braking force and release the braking force, respectively. The outer portion 30 includes outer piston(s) 34 coupled within the outer portion 30, the outer piston(s) 34 operating to move an outer brake pad 36 toward and away from a rotor 80 in order to brake and release the brake, respectively. The inner piston(s) 24 and the outer piston(s) 34 have piston bores 23 and 33 respectively that are in communication with each other such that the inner brake pad 26 and the outer brake pad 36 operate simultaneously when pulling a brake lever (not shown) to move the brake pads 26 and 36 toward each other and clamp the rotor 80 to apply a braking force to the rotor 80. The brake pads 26 and 36 are then simultaneously moved away from each other thereby releasing the braking force on the rotor 80 in response to releasing the brake lever.

The monoblock disc brake caliper 10 includes a bore extending from a brake line aperture 21 to an inner piston bore 23 within the inner portion 20. The inner portion 20 then includes an inner transfer port 22 that extends from the inner piston bore 23 to intersect with an outer transfer port 32 of the outer portion 30 of the caliper 10. The outer transfer port 32 may then extend to an outer piston bore 33. The outer portion 30 also includes a bore extending from the outer piston bore 33 to a bleeder aperture 31. These ports and bores provide the communication of brake fluid through the caliper 10 to engage and disengage the brake pads 26 and 36 with the rotor 80. In operation to engage the brake pads, the pulling of the brake lever flows fluid from a master brake cylinder (not shown) through brake line 50 in a direction 60 toward the caliper 10. The brake fluid then travels through the brake line aperture 21 through a bore extending to the inner piston bore 23 along direction arrow 62.

In calipers 10 (as shown with 4-pistons) with more than one inner piston 24, brake fluid flows along direction 63 through a slot between the leading and trailing piston bore to form an extending inner piston bore 23. The brake fluid then flows up inner transfer port 22 in direction 64 and transfers into and flows down outer transfer port 32 in direction 66. In calipers 10 with more than one outer piston 34, brake fluid flows along direction 67 through a slot between the leading and trailing piston bore to form an extending outer piston bore 33. The fluid then flows up a bore extending from the outer piston bore 33 to the bleeder aperture 31 that is sealed with a bleeder screw 52. The flow being stopped results in increased pressure in the communication ports within the caliper 10 and the pistons 24 and 34 are then forced toward the rotor 80, resulting in the brake pads 26 and 36 applying a braking force on the rotor 80. When the brake lever is released, the pressure is released, and the brake fluid flows in the opposite direction.

In another embodiment, a 2-piston caliper having an inner piston bore and an outer piston bore may be used in place of the 4-piston caliper having the same fluid flow as described above with no slot to communicates between the leading and trailing piston bores. In another embodiment, a 6-piston caliper having three inner piston bores and three outer piston bores may be used in place of the 4-piston caliper having the same fluid flow as described above with two slots provided within the inner portion and two slots provided within the outer portion of the 6-piston caliper.

Referring specifically to FIG. 2, the caliper 10 includes the crossover portion 12 that connects the inner portion 20 with the outer portion 30 and forms a rotor gap 14. The inner transfer port 22 may connect with the outer transfer port 32 at transfer junction 76. The transfer junction 76 may in some embodiments be an intersection between the inner transfer port 22 and the outer transfer port 32. In other embodiments, as shown in FIG. 2, the transfer junction 76 may be an increased volume transfer junction 76 that extends below the intersection of the inner transfer port 22 and the outer transfer port 32, thereby creating a greater volume than the transfer junction 76 that ends at the intersection of the inner transfer port 22 and the outer transfer port 32. The increased volume transfer junction 76 operates to allow better fluid flow from the inner transfer port 22 to the outer transfer port 32 and lowers the transfer ports 22 and 32 relative to the caliper 10. The forming of the inner transfer port 22 and the outer transfer port 32 requires forming a transfer port aperture 71 that extends from an outer surface of the caliper 10 on the crossover portion 12 to a depth to intersect with the inner transfer port 22 and the outer transfer port 32.

The transfer port aperture 71 and inner and outer transfer ports 22 and 32 may be located about a center line 13 of the caliper 10 or asymmetric and offset from the center line 13 of the caliper 10. An annular seal surface 74 may be formed in the transfer port aperture 71, wherein the annular seal surface 74 also forms an annular O-ring recess 75. The O-ring recess 75 is coaxial with the transfer port aperture 71 and includes an inner radius that is substantially the same as the radius of the transfer port aperture 71 and an outer radius that is greater than the radius of the transfer port aperture 71. An O-ring 72 may be received within the O-ring recess 75. A transfer port plug 70 may be coupled within the transfer port aperture 71, such as through a threaded engagement as depicted. The transfer port plug 70 operates to contact and engage the annular seal surface 74 to form a metal-to-metal seal between the transfer port plug 70 and the annular seal surface 74. The transfer port aperture 71 may also be sized in order to create a frustoconical surface for the transfer port plug 70 to have a sufficient metal-to-metal seal. This is a preferred seal rather than utilizing a rubber seal, or the like, compressed between the transfer port plug 70 and the annular seal surface 74. The compressed rubber is subject to failure and leaking at higher pressures caused by engaging the brakes. The metal-to-metal seal is not subject to such leakage. As a preventative measure, the static O-ring 72 in the O-ring recess 75 operates as an anti-seepage member in the event there is an imperfect seal between the transfer port plug 70 and the annular seal surface 74.

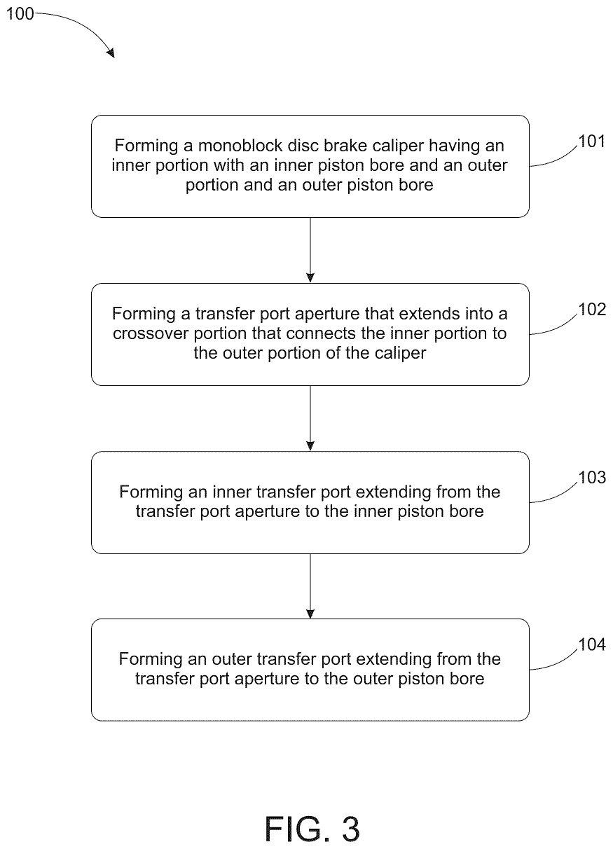

Another embodiment of the present invention may include a method 100 of manufacturing a monoblock disc brake caliper, as depicted in FIG. 3. The method 100 may include forming a monoblock disc brake caliper having an inner portion with an inner piston bore and an outer portion an outer piston bore (Step 101), wherein the caliper is a single unitary body; forming a transfer port aperture that extends into a crossover portion that connects the inner portion to the outer portion of the caliper (Step 102), wherein the transfer port aperture is located at a centerline between the inner portion and the outer portion; forming an inner transfer port extending from the transfer port aperture to the inner piston bore (Step 103); and forming an outer transfer port extending from the transfer port aperture to the outer piston bore (Step 104).

The method 100 may also include forming an increased volume transfer junction in response to forming the transfer port aperture to a location that is above, at or below an intersecting point of the axis of the inner transfer port and the outer transfer port. The method may also include utilizing the transfer port aperture to extend boring tools to form the inner transfer port and the outer transfer port, requiring only one transfer port plug to seal the transfer ports.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A monoblock disc brake caliper comprising:
an inner portion;
an outer portion;
a crossover portion formed between the inner portion and the outer portion, wherein the inner portion, the outer portion and the crossover portion are formed as a single, unitary body;
a transfer port aperture formed in the crossover portion located at a centerline of the monoblock disc brake caliper;
an inner transfer port extending from the transfer port aperture to an inner piston bore; and
an outer transfer port extending from the transfer port aperture to an outer piston bore.

2. The monoblock disc brake caliper of claim 1, further comprising a transfer junction located at the intersection of the transfer port aperture, the inner transfer port, and the outer transfer port.

3. The monoblock disc brake caliper of claim 2, wherein the transfer junction is an increased volume transfer junction formed by the transfer port aperture extending below the intersection of the inner transfer port and the outer transfer port, thereby increasing the volume compared to a transfer junction that does not extend below the intersection.

4. The monoblock disc brake caliper of claim 1, further comprising an annular seal surface formed in the transfer port aperture.

5. The monoblock disc brake caliper of claim 4, further comprising a transfer port plug that is coupled within the transfer port aperture and engages the annular seal surface to form a metal-to-metal seal.

6. The monoblock disc brake caliper of claim 5, further comprising an annular O-ring recess formed by the annular seal surface.

7. The monoblock disc brake caliper of claim 6, wherein the O-ring recess is coaxial with the transfer port aperture and comprises an inner radius that is substantially the same as a radius of the transfer port aperture and an outer radius that is greater than the radius of the transfer port aperture.

8. The monoblock disc brake caliper of claim 7, further comprising an O-ring coupled within the O-ring recess.

9. A method of manufacturing a monoblock disc brake caliper, the method comprising:
forming a monoblock disc brake caliper having an inner portion with an inner piston bore and an outer portion an outer piston bore, wherein the caliper is a single unitary body;
forming a transfer port aperture that extends into a crossover portion that connects the inner portion to the outer portion of the caliper, wherein the transfer port aperture is located at a centerline between the inner portion and the outer portion;
forming an inner transfer port extending from the transfer port aperture to the inner piston bore; and
forming an outer transfer port extending from the transfer port aperture to the outer piston bore.

10. The method of claim 9, further comprising utilizing the transfer port aperture to extend boring tools to form the inner transfer port and the outer transfer port, requiring only one transfer port plug to seal the transfer ports.

11. The method of claim 10, further comprising forming an increased volume transfer junction in response to forming the transfer port aperture to a location that is below an intersecting point of the axis of the inner transfer port and the outer transfer port.

12. The method of claim 9, further comprising forming an annular seal surface in the transfer port aperture.

13. The method of claim 12, further comprising forming an annular O-ring recess by the annular seal surface, wherein the O-ring recess is coaxial with the transfer port aperture and comprises an inner radius that is substantially the same as a radius of the transfer port aperture and an outer radius that is greater than the radius of the transfer port aperture.
